(19) United States
(12) Patent Application Publication
(10) Pub. No.: US 2011/0129347 A1
(43) Pub. Date: Jun. 2, 2011

(54) PROCESS FOR PRODUCING A JOIN TO SINGLE-CRYSTAL OR DIRECTIONALLY SOLIDIFIED MATERIAL

(75) Inventors: Dieter Schneefeld, Walkertshofen (DE); Joachim Bamberg, Dachau (DE); Johannes Gabel, Dachau (DE)

(73) Assignee: MTU Aero Engines GmbH, Munich (DE)

(21) Appl. No.: 13/055,925

(22) PCT Filed: Jun. 26, 2009
(86) PCT No.: PCT/DE2009/000890

§ 371 Date: Jan. 25, 2011

(30) Foreign Application Priority Data
Jul. 26, 2008 (DE) 10 2008 034 930.5

(51) Int. Cl. F03B 3/12; B23K 20/12

(52) U.S. Cl. 416/223 R; 228/112.1

(57) ABSTRACT

A process for producing a join between a first component and a second component is disclosed. The second component contains a single-crystal or directionally solidified material. A polycrystalline layer is produced on a joining surface of the second component for joining the second component to the first component. The joining surface of the second component is joined to the first component by friction welding.

This application claims the priority of International Application No. PCT/DE2009/000890, filed Jun. 26, 2009, and German Patent Document No. 10 2008 034 930.5, filed Jul. 26, 2008, the disclosures of which are expressly incorporated by reference herein.

### BACKGROUND AND SUMMARY OF THE INVENTION

The present invention relates to a process for producing a join between two components, one of which includes at least a single-crystal or directionally solidified material. Furthermore, the present invention relates to an integrally bladed rotor disk of a compressor or a turbine as well as a compressor and a turbine.

Single-crystal or directionally solidified materials, particularly single-crystal or directionally solidified metallic materials, are used for a series of applications. Examples are rotor blades of gas turbine engines for aircraft or other applications. These blades are simultaneously subjected to high centrifugal forces or fatigue stress in the radial direction, vibrations and high temperatures. Single-crystal or directionally solidified materials are especially suitable for these applications because of their properties.

High-strength joins may be produced by friction welding. For example, turbines blades are connected to hubs by friction welding. However, especially high mechanical welding voltages are required for friction welding single-crystal or directionally solidified materials. These especially high mechanical welding voltages require an extremely rigid design of the machines and tools that are used for friction welding. The result of this is high costs.

International Publication No. WO 2007/144557 A1 describes a friction welded join with a single-crystal component and the to-be-used orientations of the primary slip plane of a face-centered crystal lattice parallel to the oscillation direction and to the welding force.

One object of the present invention is creating an improved process for producing a join between components, one of which includes at least one single-crystal or directionally solidified material, an improved integrally bladed rotor disk of a compressor or a turbine as well as an improved compressor and an improved turbine.

Different embodiments of the present invention are based on the idea of producing a polycrystalline layer on the joining surface of a component, which includes a single-crystal or directionally solidified material, prior to connecting the joining surface to another component by friction welding.

The polycrystalline layer is produced for example by introducing deformation energy or strain energy to a thin layer close to the surface and a subsequent heat treatment. Deformation energy is introduced for example by shot peening, ultrasonic peening, the effect of neutrons, high-energy electrons or other ionizing radiation or compact rolling.

The heat treatment may be carried out prior to the friction welding in a separate process step. In this case, only a layer close to the surface may be heated by using a high heat output within a short period of time. Advantageously, only the region in which one of the previously cited measures of deformation energy or strain energy was introduced is heated to the recrystallization temperature.

Alternatively, the heat treatment may be carried out during the friction welding process itself directly before the welding of the joining surfaces. In the simplest case, after the deformation energy or strain energy is introduced, the actual friction welding process is carried out in a manner similar to known friction welding processes. Alternatively, the parameters of the friction welding process are selected for example in such a way that initially only a layer close to the surface is heated to the recrystallization temperature and kept at this recrystallization temperature during a time interval of a predetermined duration. This predetermined duration is selected in such a way that the polycrystalline layer forms. Afterwards, the actual friction welding process takes place, in that, for example, the temperature on the joining surface is briefly increased to the required value by increasing the surface normal force or the amplitude or the frequency of the friction.

The component pretreated in this manner may be connected by friction welding to a component with a single-crystal or directionally solidified material that is optionally pretreated in a similar manner or to a component with a polycrystalline material.

Examples of components to be connected in accordance with the described process are blades of a compressor or a turbine. Each blade is connected to an adapter in one of the ways described above, which adapter is in turn connected to a hub or rotor disk. Alternatively, the blades are directly connected to the hub of the rotor disk in one of the ways described above.

Integrally bladed rotor disks for compressors or turbines whose blades include a single-crystal or directionally solidified material may be created with the described process. The blades respectively have a polycrystalline layer on their joining surfaces. The polycrystalline layer may have a thickness of several micrometers to several millimeters. For some materials, a thickness of at least 0.3 mm is advantageous. A compressor or a turbine or a gas turbine engine for an aircraft or another application may have several of these types of integrally bladed rotor disks.

The advantage of different embodiments of the present invention is that the mechanical welding voltage required for forming the friction welding join is lower than it would be without a previous formation of a polycrystalline layer.

Additional embodiments of the present invention are based on the idea of arranging the joining surface on the second components parallel to a crystallographic plane of the {001} type during the friction welding of a first component to a second component, which includes a single-crystal or directionally solidified material. This has proven to be advantageous, for example, in comparison to conventional friction welding on a plane of the {111} type, above all with respect to the required surface normal force.

Embodiments will be described in greater detail in the following on the basis of the enclosed figures.

### BRIEF DESCRIPTION OF THE DRAWINGS

FIG. 1 is a schematic representation of two components to be connected by friction welding;

FIG. 2 is a schematic representation of a rotor disk; and

FIG. 3 is a schematic flow chart of a process for producing a join, a rotor disk, a compressor or a turbine.

### DETAILED DESCRIPTION OF THE DRAWINGS

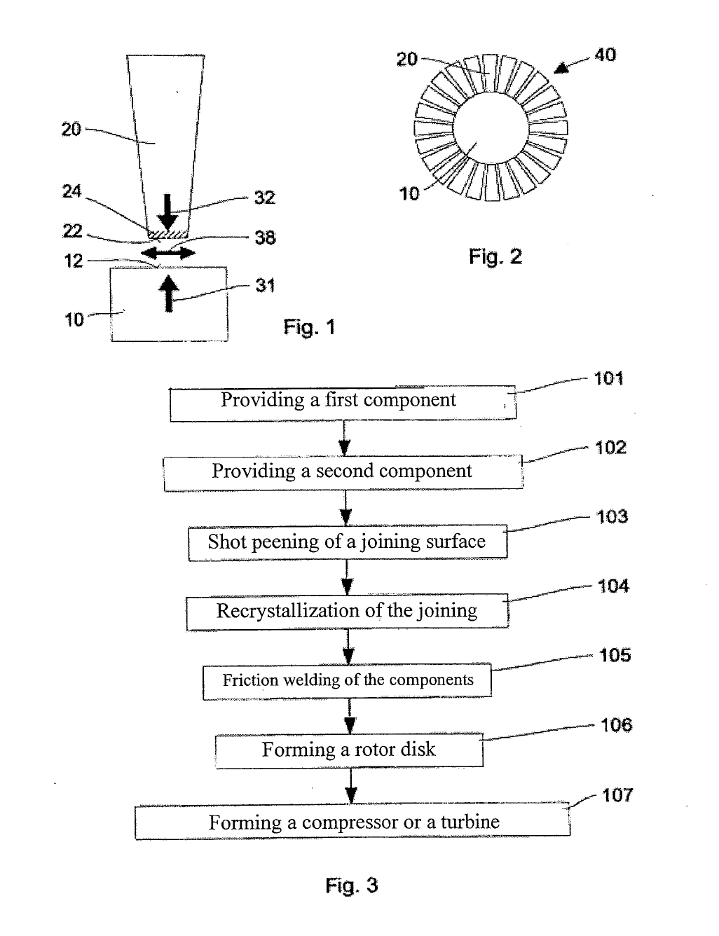

FIG. 1 shows a schematic representation of a first component 10 with a joining surface 12 and of a second component 20 with a joining surface 22. The first component 10 is a hub for a rotor disk for example. The second component 20 in this case is for example a blade for the rotor disk. The first component 10 includes a polycrystalline material. The second component 20 includes a single-crystal or directionally solidified material. The materials of the first component 10 and of the second component 20 may be similar or different except for their crystalline or microscopic structures. For example, both materials of the first component 10 and of the second component 20 are metallic materials.

To produce a join between the first component 10 and the second component 20, first of all, a polycrystalline layer 24 (shown hatched in FIG. 1) is produced on the joining surface 22 of the second component 20. To do so, the joining surface 22 of the second component 20 is initially pretreated, for example, by shot peening, ultrasonic peening or compact rolling. Good results were obtained with compressive stress of 500 MPa or more and an effective depth of treatment of 0.3 mm or more. Because of this treatment, deformation energy or strain energy is introduced to the originally single-crystal or directionally solidified material of the second component 20 near its joining surface 22. Then the second component 20 or at least a region adjacent to the joining surface 22 is subjected to brief heat treatment. This heat treatment is carried out, for example by inductive heating. In the process, a temperature near or above the recrystallization temperature is produced. Because of the deformation energy or strain energy introduced, the material recrystallizes in a polycrystalline manner.

Instead of a heat treatment in a separate step before the friction welding process, a heat treatment integrated into the friction welding process is also possible, such as the alternative described below on the basis of FIG. 3.

After the polycrystalline layer 24 is produced on the joining surface 22 in the second component 20, the first component 10 and the second component 20 are connected or joined by friction welding. To do so, the joining surface 12 of the first component 10 and the joining surface 22 of the second component 20 are pressed together with a high surface normal force. This surface normal force is represented by the arrows 31, 32. At the same time, the first component 10 and the second component 20 and thus in particular the joining surface 12 of the first component 10 and the joining surface 22 of the second component 20 are moved relative to one another. This relative movement is for example an oscillation movement in one direction or (with two different frequencies) in two different directions. The oscillation movement is indicated by the arrow 38. The developing frictional heat results in a welding of the joining surfaces 12, 22 of the components 10, 20.

Because of the polycrystallinity of the layer 24 on the joining surface 22 of the second component 20, joining by friction welding is possible with a surface normal force, which is considerably lower than would be necessary if the material of the second component 20 were also single-crystal or directionally solidified on its joining surface 22. The equipment costs, in particular the required rigidity of the tools used and the load for the components 10, 20, are considerably lower as a result.

The depicted friction welding join is particularly suited for connecting components, which are subject to high mechanical stress, for example, centrifugal forces and/or fatigue stress. An example is the connection between a blade and a hub or between a blade and an adapter to be subsequently connected to a hub to form a rotor disk of a compressor or a turbine of a gas turbine engine for an aircraft or for other applications. In this case, the second component 20 is the blade and the first component 10 is the adapter or the hub.

In order to be able to use the full strength potential of the single-crystal or directionally solidified material of the second component 20, the direction of the initiation of the welding force is advantageously selected parallel to the primary crystal orientation direction of the <100> type. In this case, the oscillation movement 38 during friction welding advantageously lies in a crystallographic plane of the {100} type of the material of the second component 20. In order to achieve a high resistance against creep and thermal fatigue in the main stress direction, the [001] direction deviates from the main stress direction and the stacking axis of the second component 20 (also called the Z axis) by a maximum of 15 degrees. The main stress direction and the stacking axis correspond in the case of a rotor disk to the radial direction. The secondary orientation (rotation of the crystal lattice around the Z axis) is unimportant for many applications.

The described orientation of the joining surface parallel to a crystallographic plane of the {001} type is also advantageous; however, if prior to or during the friction welding process there is no recrystallization in a polycrystalline manner. Even when connecting a joining surface on which the material is single-crystal or directionally solidified to another component, an orientation of the joining surface parallel to a crystallographic plane of the {001} type is advantageous. In addition to the advantages cited above, with specific materials, this orientation allows for example the use of a comparatively lower surface normal force or a reduced frequency or amplitude of the friction.

As an example of the application of the described joining process, FIG. 2 shows a rotor disk 40 made of a hub 10 and plurality of blades 20, which are connected to the hub 10 as described above on the basis of FIG. 1.

FIG. 3 shows a schematic flow chart of a process for producing a join by friction welding. Although this process can also be used for components that have features other than those depicted above in FIG. 1, reference numbers from FIG. 1 will be used in an exemplary manner in the following for the sake of simplicity.

A first component 10 is provided in a first step 101. In a second step 102, a second component 20 is provided, which includes a single-crystal or directionally solidified material.

In a third step 103 and a fourth step 104, a polycrystalline layer 24 is produced in the material on the joining surface 22 of the second component 20. The polycrystalline layer 24 is produced in this example in that to begin with the joining surface 22 is treated by shot peening or ultrasonic peening or compact rolling in the third step 103.

Then, in a fourth step 104, the joining surface 22 of the second component 20 and at least a partial region of the second component 20 adjacent to the joining surface 22 are subjected to a (if applicable, local) heat treatment. This heat treatment is carried out in a separate process or in a process with the friction welding described below. In this case, the material recrystallizes in a polycrystalline manner due to the deformation energy or strain energy introduced in the third step 103.

If the first component 10 also includes a single-crystal or directionally solidified material, a polycrystalline layer is preferably also produced on the joining surface 12 of the first component 10, for example in process steps corresponding to the third step 103 and the fourth step 104.

In a fifth step 105, the first component 10 and the second component 20 are connected or joined to each other by friction welding, in particular by linear friction welding. The polycrystallinity of the layer 24 reduces the surface normal force 31, 32 and the force required to produce the oscillation movement 38, which are necessary to form the friction welding join.

The fourth step 104 and the fifth step 105 may be partially or completely integrated. The heat treatment may be carried out in the course of the friction welding directly before or during the welding of the joining surfaces. The friction process may be controlled in a similar manner to a conventional friction process. Alternatively, the friction process may be controlled such that, first of all only a layer close to the surface is heated to the recrystallization temperature and kept at this recrystallization temperature during a time interval of a predetermined duration. This predetermined duration is selected in such a way that the polycrystalline layer forms. Afterwards, the actual friction welding process takes place, in that, for example, the temperature on the joining surface is briefly increased to the required value by increasing the surface normal force or the amplitude or the frequency of the friction.

In order to form a rotor disk, the steps described above may be repeated for all blades of the rotor disk in a sixth step 106.

In an optional seventh step 107, a compressor or a turbine or a gas turbine engine may be formed from one or more rotor disks, which were formed in the sixth step 106.

1. Process for producing a join between a first component (10) and a second component (20), wherein the second component (20) contains a single-crystal or directionally solidified material, having the following steps:
Providing (101) the first component (10);
Providing (102) the second component (20) with a joining surface (22) provided for joining the second component (20) to the first component (10);
Producing (103, 104) a polycrystalline layer (24) on the joining surface (22) of the second component (20);
Joining (105) the joining surface (22) of the second component (20) to the first component (10) by friction welding.

2. Process according to one of the preceding claims, in which the production (103, 104) of the polycrystalline layer (24) includes at least either a shot peening or an ultrasonic peening or an irradiating with neutrons, electrons or other ionizing radiation or a compact rolling.

3. Process according to one of the preceding claims, in which the production (103, 104) of the polycrystalline layer includes at least either an inductive heating or a different local heat treatment or a different heating to at least a recrystallization temperature of the material of the second component (20).

4. Process according to one of the preceding claims, in which the first component (10) includes a single-crystal or directionally solidified additional material, furthermore having the following step:
Producing (103, 104) a polycrystalline layer in the additional material of the first component (10) on a joining surface (12) of the first component (10).

5. Process according to one of claims 1 to 3, in which the first component (10) includes a polycrystalline material.

6. Process according to one of the preceding claims, in which the second component (20) is a blade of a compressor or a turbine, and in which the first component (10) is an adapter for connecting the blade (20) to a hub of a rotor disk (40).

7. Process according to one of the preceding claims, in which the joining surface (22) is parallel to a crystallographic plane of the {001} type.

8. Process for producing a join between a first component (10) and a second component (20), wherein the second component (20) includes a single-crystal or directionally solidified material, having the following steps:
Providing (101) the first component (10);
Providing (102) the second component (20) with a joining surface (22) provided for joining the second component (20) to the first component (10), which is parallel to a crystallographic plane of the {001} type;
Joining (105) the joining surface (22) of the second component (20) to the first component (10) by friction welding.

9. Process for producing an integrally bladed rotor disk (40) of a compressor or a turbine, wherein a hub of the rotor disk is joined as the first component (10) and a blade is joined as the second component (20) according to one of the preceding claims.

10. Integrally bladed rotor disk (40) of a compressor or a turbine having the following features:
a hub (10);
a blade (20), which includes single-crystal material or a directionally solidified material,
wherein a joining surface (22) of the blade (20) is joined by friction welding to the hub (10) or to an adapter, which is connected to the hub (10), and
wherein the blade (20) has a polycrystalline layer (24) on the joining surface (22).

11. Integrally bladed rotor disk (40) according to the preceding claim, wherein the blade (20) and the hub (10) are joined according to one of the preceding process claims.

12. Integrally bladed rotor disk (40) according to the preceding claim, in which the hub (10) includes a polycrystalline material.

13. Integrally bladed rotor disk (40) of a compressor or a turbine having the following features:
a hub (10);
a blade (20), which includes a single-crystal material or a directionally solidified material,
wherein a joining surface (22) of the blade (20) is joined by friction welding to the hub (10) or to an adapter, which is connected to the hub (10), and
wherein the joining surface (22) is parallel to a crystallographic plane of the {001} type.

14. Compressor or turbine with an integrally bladed rotor disk (40) according to one of the preceding device claims.
